(19) United States
(12) Patent Application Publication
(10) Pub. No.: US 2015/0089403 A1
(43) Pub. Date: Mar. 26, 2015

(54) DYNAMIC GENERATION OF USER INTERFACE

(71) Applicants: Jin You ZHU, Singapore (SG); Xiang CAI, Singapore (SG); Yan ZANG, Singapore (SG); Lin CAO, Singapore (SG)

(72) Inventors: Jin You ZHU, Singapore (SG); Xiang CAI, Singapore (SG); Yan ZANG, Singapore (SG); Lin CAO, Singapore (SG)

(21) Appl. No.: 14/032,196

(22) Filed: Sep. 20, 2013

(51) Int. Cl. G06F 3/0484

(52) U.S. Cl. CPC G06F 3/0484
USPC 715/762

(57) ABSTRACT

Described herein is a technology to dynamically generate a user interface (UI). In one implementation, a data source is analyzed to determine field information of the data source. UI controls are mapped to fields of the data source based on the field information to generate UI control mapping information. Based on the field information and the UI control mapping information, a layout may be generated. The layout may then be presented for preview.

### TECHNICAL FIELD

The present disclosure relates generally to dynamically generating a user interface (UI).

### BACKGROUND

To include data in a user interface, a data source is typically set up to obtain digitized data. A data source is also known as a data connection, and typically includes the data source type, connection information and the type of credentials to use. A data source may include, for instance, a database, a Representational State Transfer (RESTful) Web Service, Open Data Protocol (OData) service, a file containing data, a data stream, etc. Through a data source, a client device can, for example, retrieve, insert, update and/or delete a record from or into a backend data server.

In order to use the data from the data source accurately and present the data in a user-friendly manner, it is important for the client device to know the exact type and format of the data. For some types of data sources, the developer may need to manually analyze the data and determine the data types and formats of each column of data. Based on the data types and formats, the developer then manually determines what format to use for presentation and manually maps the UI presentation controls to the data source. Such process is tedious and unproductive.

Therefore, there is a need for an improved framework that addresses the above-mentioned challenges.

### SUMMARY

A technology to dynamically generate a user interface (UI) is described herein. In accordance with one aspect of the technology, a data source is analyzed to determine field information of the data source. UI controls are mapped to fields of the data source based on the field information to generate UI control mapping information. Based on the field information and the UI control mapping information, a layout may be generated. The layout may then be presented for preview.

In accordance with another aspect, a data source is analyzed to determine column information of the data source. UI controls are mapped to columns of the data source based on the column information to generate UI control mapping information. One or more user selections of one or more of the columns are received. Based on the column information and the UI control mapping information, a layout of one or more of the UI controls associated with the one or more user-selected columns may be generated. The layout may then be presented for preview.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures. Like reference numerals in the figures designate like parts.

FIG. 1 shows an exemplary architecture;

FIG. 2 shows an exemplary process for analyzing a data source;

FIG. 3 shows an exemplary process for mapping UI controls;

FIG. 4 shows an exemplary process for interactively generating a layout; and

FIGS. 5a-5c show screen shots of an exemplary user interface presented by the dynamic UI generator.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of present frameworks and methods, and to thereby better explain the present frameworks and methods. Furthermore, for ease of understanding, certain method steps are delineated as separate steps; however, these separately delineated steps should not be construed as necessarily order dependent or being separate in their performance.

A technology for facilitating dynamic generation of a user interface (UI) is described herein. One aspect of the technology provides an intelligent and generic framework for analyzing different types of data sources. The results of the data source analysis provide clear information of the format of data provided by the data sources. Such information may include, but are not limited to, the number of fields (e.g., columns), the type and format of each field, etc. Based on this information, the client device can advantageously provide a better data presentation, data handling and intelligent operation.

Another aspect of the present technology dynamically generates UI controls (or widgets) based on the type of data source. A “UI control” generally refers to an element of a graphical user interface (GUI) that displays an information arrangement, such as a window or a text box. Based on the data source analysis, the present technology can determine which UI control to use for a particular type of data, and present the data in a more user-friendly and meaningful way. For instance, if the data from the data source has a date/time format, a date/time picker or a calendar control can be dynamically generated or used for the presentation. If the data includes a phone number, a mask or format may be applied to the generated UI control to present the data.

Such dynamic generation of UI controls is more efficient than traditional approaches that only allow for static configuration and manual mapping of UI controls to a data source. By using the present technology, developers or other users may review UI controls suggested based on the data source analysis results, and change the presentation styles according to their preferences. Developers may also choose whether the particular data is editable via the UI control. For editable UI controls, the technology may analyze the data to automatically determine and suggest what kind of input method (e.g., keyboard) to use. The developers can also change the suggested input method. These and other advantages and aspects will be described in more detail in the following description.

For purposes of illustration, the following description may be provided in the context of column-based or column-oriented data sources. However, it should be appreciated that the present technology can also be applied to other types of data sources, such as row-based or row-oriented data sources, and other field-based data sources. In addition, the technology described herein may be implemented as a method, a computer-controlled apparatus, a computer process, a computing system, or as an article of manufacture such as a computer-usable medium. These and various other features will be apparent from the following description.

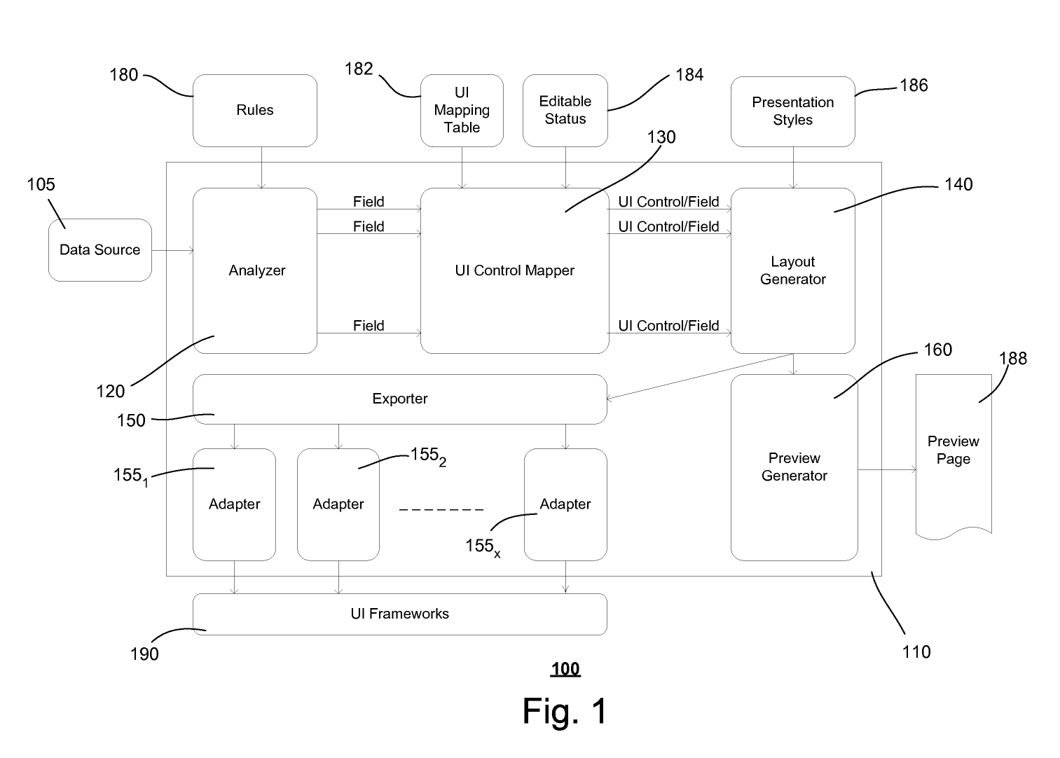

FIG. 1 shows a block diagram of an exemplary embodiment of a dynamic UI generator 110. The data analyzer, for example, may be employed in an environment 100. The environment may have a client/server architecture. For example, the environment may be a distributed client/server architecture. A client/server architecture may have one or more clients and one or more servers communicatively coupled via a communication network. The communication network, for example, may be a local area network (LAN) which interconnects different devices, such as the clients and server. Other types or configurations of networks may also be useful. For example, the network may be interconnected to other networks through wide area network (WAN) or internet. The devices may be coupled via the network by wireless and/or wired connections. Clients may access the server or servers for storage or retrieval of information. Furthermore, a server may facilitate communication between clients.

A server, in one embodiment, may be a computer which includes a memory and a processor. The memory of a server may include any non-transitory computer-readable media. The memory may be volatile or non-volatile types of memories, such as magnetic media, optical media, random access memory (RAM), read-only memory (ROM), removable media, or any other suitable local or remote memory component. The server is configured to transmit, receive, process and store information or data associated with the environment. Various types of computers may be employed. For example, the computer may be a mainframe, workstation, as well as other types of processing devices. The server may be adapted to execute any operating system. For example, the operating system of the server may be z/OS, Linux-Intel, Linux/390, UNIX, or Windows Server. Other types of operating systems may also be used. The server may also include or be communicatively coupled with a web server and/or a Simple Mail Transfer Protocol (SMTP) server.

A client may be a local or remote computing device with, for example, local memory and a processor. The memory may include fixed and/or removable storage media such as a magnetic computer disk, CD-ROM, or other suitable media. Various types of processing devices may serve as a client. For example, the client may be a PC, tablet PC, workstation, network computer, kiosk or a mobile computing device, such as a laptop, a tablet or a smart phone. Other types of processing devices may also be used. A client can receive, transmit, process and store any appropriate data associated with the architecture.

Client/server (C/S) applications may be provided in the environment. Generally, C/S applications include front end and backend portions. The front end portions are stored locally on the clients while the backend portions are located in the server. Various types of C/S applications may be provided in the environment. The C/S applications, for example, may include business applications. Such applications, for example, maintain data of a business or company and may include, for example, SAP Crystal Solutions, including Xcelsius, Crystal Reports, or Web Intelligence from SAP AG. Other types of applications, including non-C/S applications, may also be useful.

The dynamic UI generator 110 is a software tool for dynamically generating a UI or presentation based on data retrieved from a data source. The dynamic UI generator may be integrated into a data presentation application. Providing the dynamic UI generator 110 as a stand-alone tool, such as a C/S application, desktop or mobile application, may also be useful. Other configurations of the dynamic UI generator may also be useful.

The dynamic UI generator 110 includes various modules. In one embodiment, the dynamic UI generator 110 includes a data source analyzer module 120, a UI control mapper module 130, an intelligent or smart layout generator module 140, an exporter module 150 with adapters 155₁₋ₓ and a preview generator module 160. Providing other modules or configurations of modules for the dynamic UI generator 110 may also be useful. It should be appreciated that such modules are not necessarily implemented separately, and may be integrated, or divided into further modules. For example, the preview generator 160 may be integrated with the layout generator 140.

External input may be provided to the UI generator 110 to facilitate the dynamic generation of UI. The external input may be provided via the client or server side. In one embodiment, external input includes a data source 105, analysis rules 180, a UI mapping table 182, editable status 184 and definitions of presentation styles 186 (e.g., table, list, grid, tree, carousel, card, etc.). Data source 105 is any data connection that provides digitized data. Data source 105 may include, for instance, a database, a Representational State Transfer (RESTful) Web Service, Open Data Protocol (OData) service, a file containing data, a data stream, etc. Data source 105 may have any format, with or without metadata information. The format of the data source need not be known to the UI generator prior to analysis. Multiple data sources 105 may be provided. For example, multiple data sources 105 may be sequentially provided in a list or array for analysis by the analyzer 120.

Data source analyzer module 120 analyzes the data source 105. In one embodiment, data source analyzer module 120 analyzes the data source 105 to determine field information of the data provided by the data source 105. A data field generally refers to a place where data is stored. Data that has several parts can be divided into multiple fields. For instance, in the context of a column-oriented relational database, data may be arranged as sets of database records (i.e., rows), where each record may include several fields (i.e., columns).

Based on the field information (e.g., column information), UI control mapper 130 selects or maps the fields of the data source 105 to appropriate UI controls based on the UI mapping table 182. Additionally, the mapper 130 may select editable control for editable fields based on editable status 184. Editable status 184 defines whether the data source 105 is editable by the user or not. If the data source 105 is not editable (e.g., columns are read-only), then the mapper 130 may not allow the user to select an editable UI control (e.g., input control). If the data source 105 is editable, however, the mapper 130 may allow the user to select which fields (e.g., columns) they want to update or edit. For fields that the user wants to update or edit, an editable control may be mapped to those fields.

In some implementations, layout generator 140 dynamically generates the layout or presentation of data based on the selected UI controls generated by the mapper 130, presentation styles 186 and field information from the data analyzer 120. Presentation styles 186 may provide guidance as to the types of layout to use for optimal presentation. The layout may be optimized in accordance with best practices. In some implementations, layout generator 140 further presents a dialog box or other UI element to allow the user to make any changes or fine-tune the generated layout as desired.

Preview generator 160 may generate a preview page 188 to present to the user to view the presentation (or UI) generated by the layout generator 140. The preview page 188 may be presented in substantially real-time. If the user finds that the generated UI is unsatisfactory, the user may make changes to the mapping via the UI control mapper 130 or the layout via the layout generator 140.

The output of the layout generator 140 may be in the form of a presentation or aggregation of UI controls. The output presentation may be stored in, for example, a file containing the UI control definitions, or a composite object for the UI. Exporter 150 may export the output presentation to different UI frameworks using adapters 155₁₋ₓ. Exemplary UI frameworks include, but are not limited to, SAP UI5, JQuery-based UI framework, Sencha Ext JavaScript UI framework, etc. Each adapter 155₁₋ₓ may be developed for a particular UI framework. The user may also add one or more custom adapters for their own UI frameworks 190.

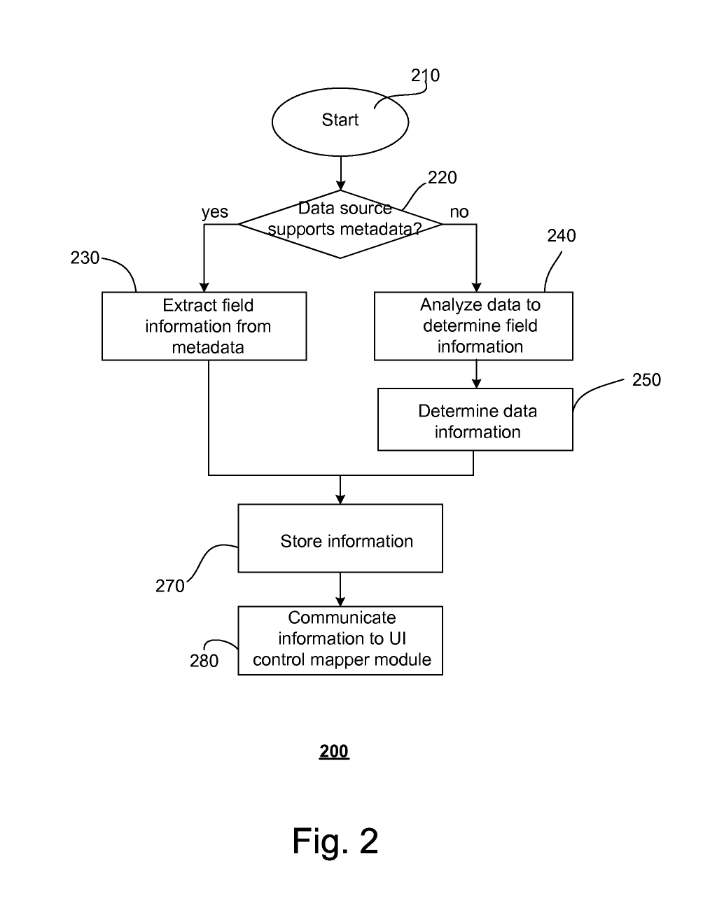

FIG. 2 shows an exemplary process 200 for analyzing a data source. The process 200 may be implemented by the data source analyzer module 120, as previously described with reference to FIG. 1. It should be noted that in the following discussion, reference will be made, using like numerals, to the features described in FIG. 1.

At 210, the process 200 may start with the analyzer module 120 connecting with a data source 105. If multiple data sources are provided, they may be processed sequentially by repeating the process 200 for each data source 105.

At 220, the analyzer module 120 determines if the data source 105 supports metadata from which field information of the data provided by the data source 105 may be derived. For example, some types of data sources (e.g., databases, OData service, etc.) provide metadata from a backend server that provides information about the types and formats of each column or field of the data. For other types of data sources (e.g., RESTful Web Service, XML, JavaScript Object Notation (JSON) file, etc.), it may not be possible to obtain such metadata.

If the data source 105 supports metadata, the process 200 proceeds to step 230. At 230, the analyzer module 120 retrieves the metadata information from the data source 105 and extracts field information directly from the metadata. In some implementations, field information includes, for instance, field names, field formats and field types. Other types of field information, such as “nullable”, “primary key”, etc., may also be included. A field format specifies how data is stored or represented. For example, a DateTime format may define the text representation of a date and a time value. A field type may include a simple type or a complex type.

A simple field type stores a data element that does not contain other data elements, while a complex field type stores a data element that is composed of other data elements (e.g., in a multi-level tree or hierarchical structure). Exemplary simple field types include, but are not limited to, integer, string, double, DateTime, and so forth. Exemplary complex field types include, but are not limited to, array, object, tree, etc.

In the case of a complex field type, the analyzer module 120 may perform a recursive (or hierarchical) drill down of the metadata associated with each complex field to extract information of the next lower level of sub-fields until the lowest level of simple field types is reached. For instance, for each complex column, the analyzer module 120 recursively drills down each column to obtain the information of the next level of sub-columns until the leaf nodes associated with simple columns are reached. After extracting field and any sub-field information, the process 200 proceeds to step 270.

In the event that the data source 105 does not support metadata, the process proceeds to step 240. At 240, the analyzer module 120 analyzes the data of the data source 105 to determine or predict field information (e.g., field type, field format, etc.). For example, the analyzer 120 may predict column information of the data source 105, such as column types and formats at step 240.

In one embodiment, pre-defined analysis rules 180 are provided to assist the analyzer module 120 in determining field information. The analysis rules 180, for example, provide mapping between data formats and data types. Such data formats and data types may be used to infer field format and field type. In some implementations, data type may be determined based on the data format by using the analysis rules 180. For example, if the data contains a certain format, its type may be determined using the mapping provided by the analysis rules 180. The analysis rules 180 may be pre-defined by the user or the analyzer module 120. Such rules 180 may be stored as a list of mapping rules or any other format (e.g., XML or JSON). In addition, the rules may be stored in internal storage (e.g., provided by analyzer module 120) or external storage (e.g., provided by user).

An exemplary embodiment of analysis rules is provided below:

[

{

“format”:”anything”,
“type”: “string”

},
{

“format”:xx.xxx,
“type”: “decimal”

},
{

“format”:”mm/dd/yyyy”,
“type”: “date”

},
{

“format”:”hh:mm:ss”,
“type”: “time”

},
{

“format”:”xxx-xxx-xxxx”,
“type”: “phone number”

},
{

“format”:”xxx@xxx.xxx”,
“type”: “email”

}

]

It should be appreciated that the mapping provided by the analysis rules 180 may pertain only to simple data. For complex data, the analyzer module 120 may perform a recursive (or hierarchical) drill down of the complex data type until the lowest level of simple data is obtained. The simple data may then be mapped according to the analysis rules 180.

At 250, the analyzer module 120 analyzes the data to dynamically determine additional data information. Such data information may include, for instance, row information, on-demand retrieval support, filters, etc. To determine filter support, for example, the analyzer module 120 may assume that the data source 105 supports filters and attempt to get data. If successful, it is determined that the data source 105 supports filters. After determining data information, the process 200 proceeds to step 270.

At 270, the analyzer module 120 stores the field information and data information. The field and data information may be stored in storage internal or external to the server or client that the analyzer module 120 is implemented on. In some implementations, the field and/or sub-field information is stored in a field information data structure or file using any suitable format (e.g., XML, JSON, etc.). For instance, each field information file may store a list of columns. Providing the field information in other formats may also be useful. Multiple field information files may be provided for multiple data sources.

As discussed previously, the field (or data) type may be a simple or complex. An example of a simple column format definition that may be stored in a field information file is provided below:

{

“column name”: “DOB”,
“type”: “datetime”,
“format”: “mm/dd/yyyy”
“array”: false

}

An example of a complex column format definition stored in a field information file is provided below:

{

“column name”: “address”,
“type”: “object”,
“format”: null,
“array”: false,
“sub columns”:
[

{
“column name”: “name”,
“type”: “string”,
“format”: null,
“array”: false
},
{
“column name”: “tel”,
“type”: “phone#”,
“format”: “xxx-xxx-xxxx”,
“array”: false
}

]

}

The process 200 then proceeds to step 280, wherein the information is communicated to, for example, the UI control mapper module 130. This, for example, completes the data analysis by the data source analyzer module 120.

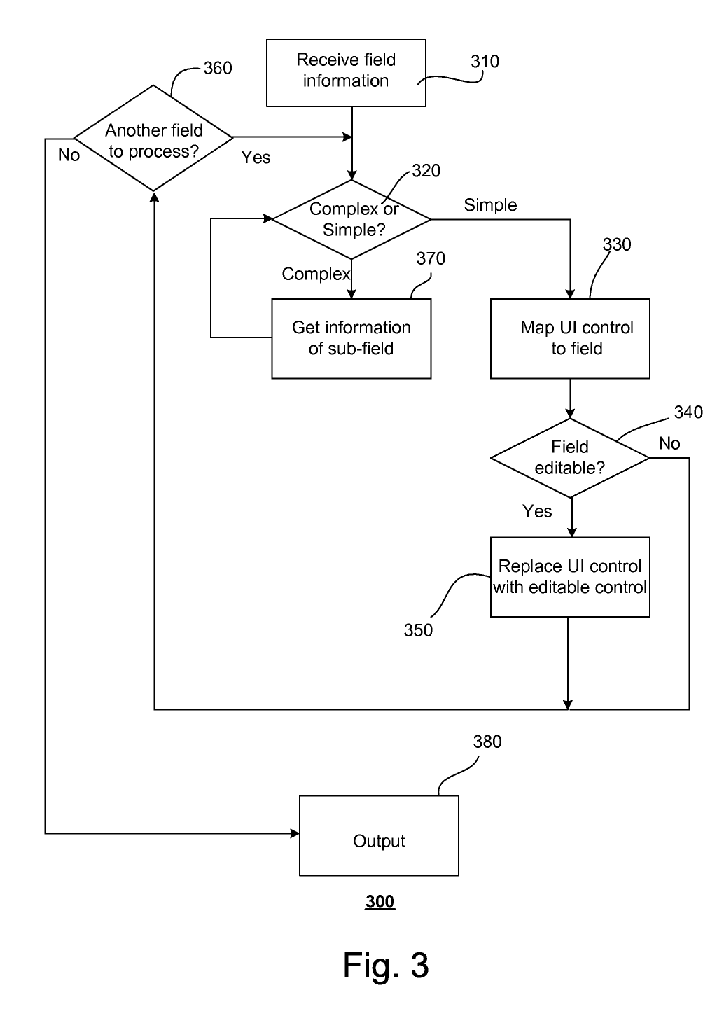

FIG. 3 shows an exemplary data-sensitive process 300 for mapping UI controls to the fields of the data source 105. The process 300 may be implemented by the UI control mapper module 130, as previously described with reference to FIG. 1. It should be noted that in the following discussion, reference will be made, using like numerals, to the features described in FIG. 1.

At 310, the UI control mapper 130, at step 310, receives field information from, for instance, the data analyzer module 120. For example, the results of the data analyzer module 120 are provided to the UI control mapper module 130. It should be appreciated that the field information may also include sub-field information for complex data types, if any, as previously described.

At 320, for each field (e.g., column) described by the field information, the UI control mapper 130 determines if it is a simple or complex field.

If the field is a simple field type, at 330, the UI control mapper 130 maps a UI control to the simple field. The mapping, for example, is based on a pre-defined UI mapping table 182. The mapping table 182 may be a default mapping table which includes default UI control and field type pairings. In some cases, the mapping table 182 maps or associates one UI control to one field. The mapper 130 may provide a user the option to use a custom mapping table 182. For example, a user may select the option to use a custom mapping table, overriding the default mapping table. The custom mapping table 182 contains UI control and field pairings defined by the user. In some cases, a user may provide a custom UI control mapping table 182.

After mapping the UI control to the field, the user may select to make the field editable or not at step 340. The user may choose to make the field editable if the data source is editable. If the data source is not editable or the user does not choose to make the field editable, the UI control remains read-only and the process 300 continues to step 360. On the other hand, if the data source is editable and an editable field is selected, the process continues to step 350. At 350, the mapped UI control is replaced with an editable UI control (e.g., input control). The process 300 then continues to step 360.

The editable status of each field may be stored in, for example, an editable status table 184. The mapping table 182 and editable status table 184 may be integrated into a single table. For example, the editable status table 184 may be integrated into the mapping table 182. An exemplary embodiment of a mapping table with editable status is provided below:

[

{

“type”: “datetime”,
“control”: “DateTimePicker”,
“property”:”value”

},
{

“type”: “time”,
“control”: “TimePicker”,
“property”:”value”

},
{

“type”: “date”,
“control”: “DatePicker”,
“property”:”value”

},
{

“type”: “boolean”,
“control”: “CheckBox”,
“property”:”value”

},
{

“type”: “string”,
“editable”: [

{
“value”:”true”,
“control”:”TextArea”,
“property”:”text”
},
{
“value”:”false”,
“control”:”Label”,
“property”:”text”
}

]

},
{

“type”: “decimal”,
“editable”: [

{
{“value”:”true”,
{“control”:”Input”,
{“property”:”value”
},
{
“value”:”false”,
“control”:”Label”,
“property”:”text”
}

]

}

]

At 360, the mapper 130 determines if there is another field described by the field information that is yet to be processed. If there is another new field to be processed, the process 300 continues at 320 to determine if the new field is complex or simple. If no other field needs to be processed, the process 300 continues at 380 to generate an output.

At step 380, the mapper 130 generates an output of the mapping. The output includes, for example, mappings between fields and corresponding UI controls. The output may further include mapping or binding properties or values for each UI control. In some implementations, the default property of a UI control is defined by the most used property. The user may also be provided with a choice to change the property. For instance, for an input control, the property “Value” may be used to bind to the field. For “Label” control, the property of “Text” may be used for the binding. The output of the mapper module 130 is provided to the layout generator module 140.

For the case where the field is determined to be a complex field at 320, the process 300 proceeds to step 370. UI control mapper 130 may recursively drill down each complex field until the lowest level simple sub-field is obtained. For instance, the UI control mapper 130 may drill down the complex field to a lower level to obtain sub-field information. After obtaining the sub-field information, at 320, the UI control mapper 130 determines if the sub-field is complex or simple. If it is simple, the process 300 continues at 330 to map a UI control to the simple sub-field. If the sub-field is complex, the process continues at 370 to drill down again from the sub-field to obtain information of another sub-field at the next level. The steps 320 and 370 may be repeated until a simple sub-field is found, at which point, the process 300 proceeds to step 330 to map a UI control to the simple sub-field. Alternatively, instead of drilling down a complex field at 370, the process 300 may map a complex control to the complex field, and the process continues at step 360 to process any additional fields.

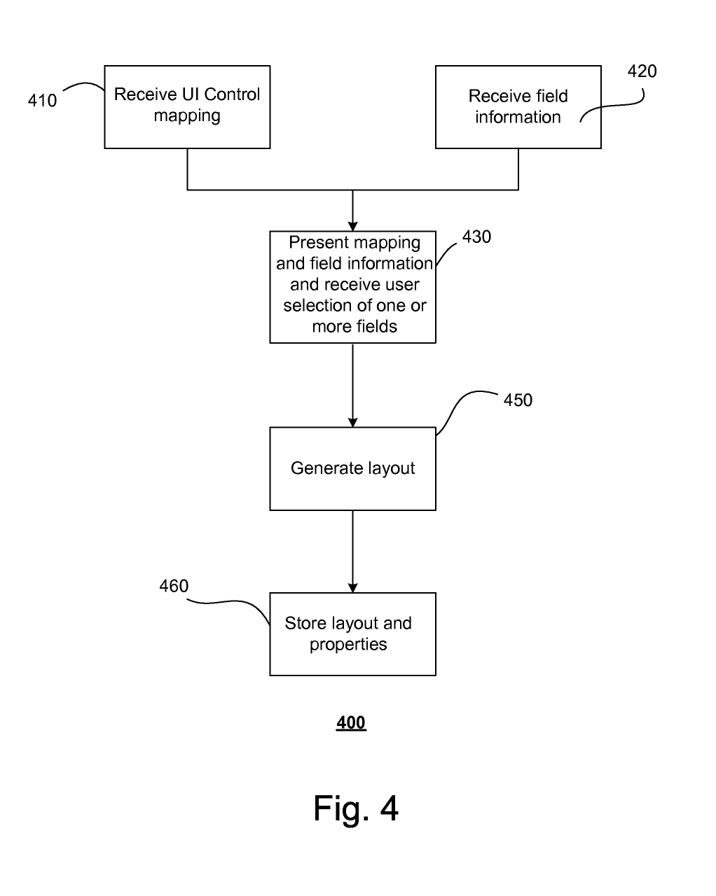

FIG. 4 shows an exemplary interactive process 400 for generating a layout. The process 400 may be implemented by the layout generator module 140, as previously described with reference to FIG. 1. It should be noted that in the following discussion, reference will be made, using like numerals, to the features described in FIG. 1.

At 410, the layout generator module 140 receives the output mapping from the UI control mapper 130. For example, the mappings of UI controls to fields (or sub-fields) may be received. At 420, the layout generator module 140 receives field information (e.g., column information) from the analyzer module 120. At 430, the layout generator module 140 presents the field and mapping information to the user. The user then selects the field or fields to display in the final layout.

At 450, in response to receiving the user selection of one or more fields, the layout generator module 140 generates a layout of the UI controls suggested for the selected one or more fields. The suggested UI controls may be retrieved from the UI control mapping information. For example, the layout generator module 140 may look-up the UI controls that have been mapped to the selected fields. A user may interactively make changes to the layout, if desired. At 460, the layout generator 140 stores the final layout and any associated properties in a suitable data structure.

The final layout and properties generated may be used by the preview generator 160 as a template. The preview generator 160 may also retrieve real-time data corresponding to the selected fields from the data source 105 and generate a preview page 188 with the data. The exporter module 150 and adapters 155_{1-X} may be used to export the generated layout or UI presentation to different UI frameworks (e.g., SAP UI5, JQuery, Sencha, etc.).

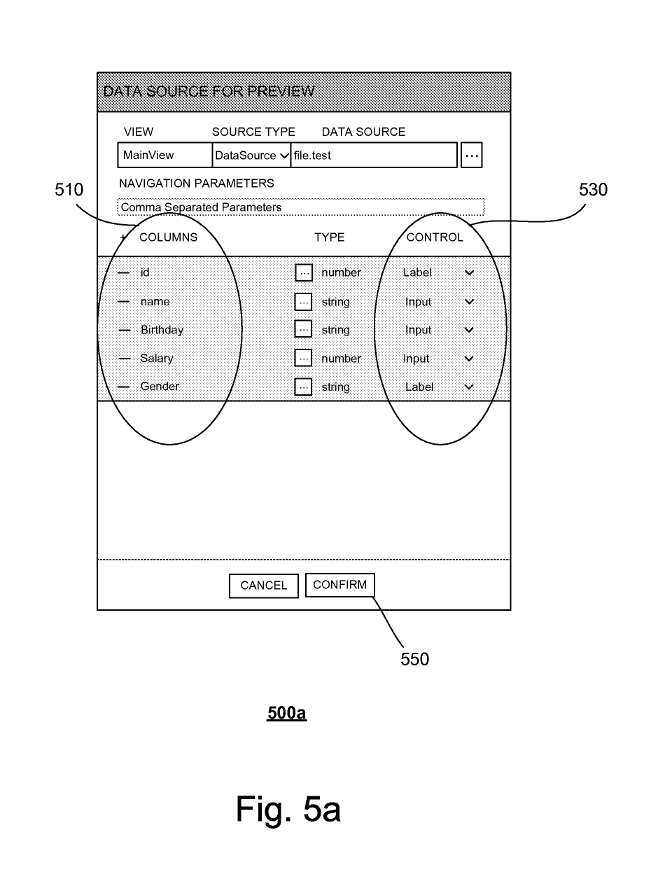

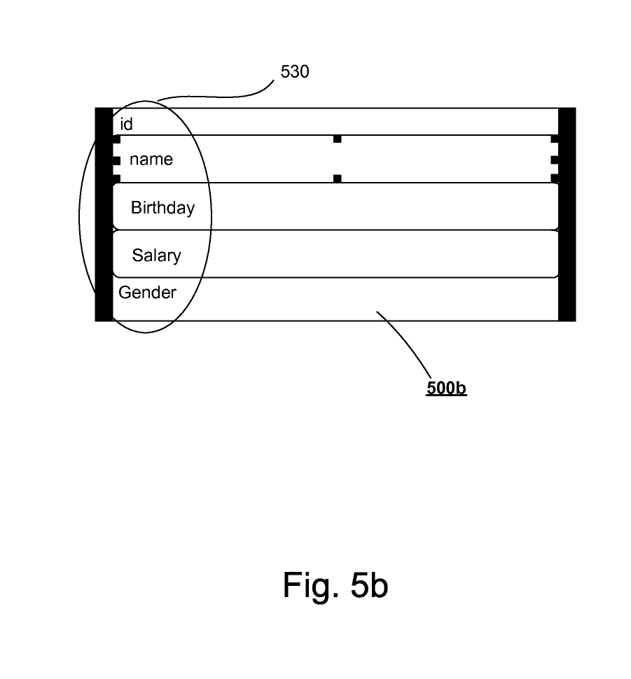

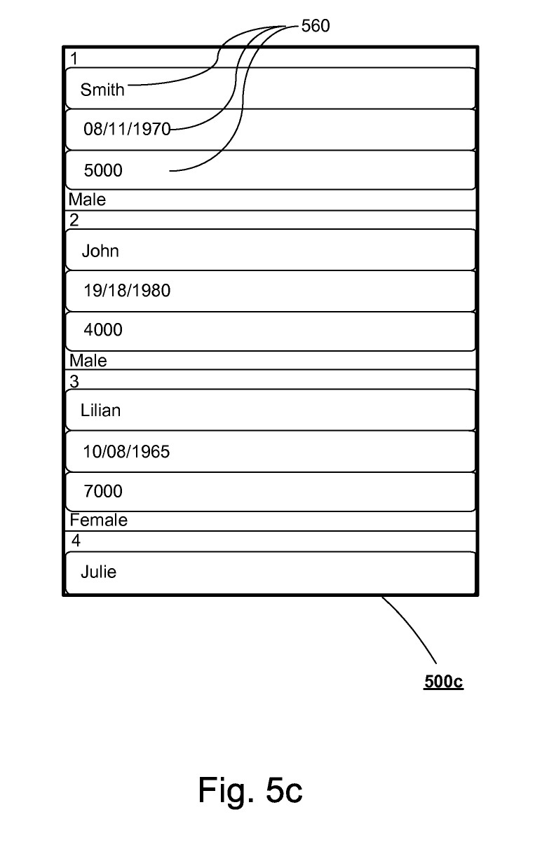

FIGS. 5a-5c show some screen shots of an exemplary user interface presented by a dynamic UI generator. More particularly, the screen shots illustrate column selection, layout generation and layout preview. Referring to FIG. 5a, a screen shot 500a displays column information of a data source and UI control mapping information. As shown, such information includes column name, column type and associated UI control. The user may select a set of columns 510. For example, the user may click on a selection box next to the column name or each column which is to be selected. The selected columns 510 are associated with or mapped to the respective UI controls 530. Once selected, the user may submit the selected columns 510 to generate a layout by clicking on the confirm button 550.

Once the selected columns 510 are submitted for processing, the layout generator dynamically generates a layout 500b, as shown in FIG. 5b. The layout 500b, as shown, includes the corresponding UI controls 530 of the selected columns. The user may make changes to the layout 500b, if desired. The final layout is then saved as a template. In FIG. 5c, the preview generator generates a preview of the layout page 500c in real time. As shown, the layout page includes data 560 retrieved from the data source from the respective columns of each data record.

As described, the dynamic UI generator may be embodied as an application. For example, the dynamic UI generator may be embodied as a software application. The application may be integrated into an existing software application, such as an App builder application, as an add-on or plug-in to an existing application, or as a separate stand-alone application. The existing software application may be a suite of software applications. The source code of the display system may be compiled to create an executable code. The code, for example, may be stored in a storage medium, such as one or more storage disks. Other types of storage media may also be useful.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A computer-implemented method of dynamically generating a user interface (UI), comprising:
analyzing a data source to determine column information of the data source;
mapping UI controls to columns of the data source based on the column information to generate UI control mapping information;
receiving one or more user selections of one or more of the columns;
generating, based on the column information and the UI control mapping information, a layout of one or more of the UI controls associated with the one or more user-selected columns; and
presenting the layout for preview.

2. A computer-implemented method of dynamically generating a user interface (UI), comprising:
analyzing a data source to determine field information of the data source;
mapping UI controls to fields of the data source based on the field information to generate UI control mapping information;
generating a layout based on the field information and the UI control mapping information; and
presenting the layout for preview.

3. The method of claim 2 wherein analyzing the data source comprises determining the field information that includes at least a field format and a field type.

4. The method of claim 2 wherein analyzing the data source comprises determining if the data source supports metadata from which the field information may be derived.

5. The method of claim 4 wherein if the data source is determined to support the metadata, automatically extracting the field information from the metadata.

6. The method of claim 4 wherein if the data source is determined to not support the metadata, analyzing data from the data source to determine the field information.

7. The method of claim 6 wherein analyzing the data from the data source comprises determining, using a pre-defined analysis rule, a data type based on a data format.

8. The method of claim 7 wherein if the data is complex, recursively drilling down the data to obtain simple data, and using the pre-defined analysis rule to map the data type of the simple data based on the data format of the simple data.

9. The method of claim 6 further comprises dynamically determining additional data information from the data.

10. The method of claim 2 wherein mapping the UI controls to the fields of the data source comprises:
determining if a field described by the field information is complex or simple; and
if the field is determined to be simple, mapping a UI control to the field.

11. The method of claim 10 wherein the mapping of the UI control to the field is based on a pre-defined UI mapping table.

12. The method of claim 10 further comprises:
determining if the field is editable; and
if the field is editable, replacing the UI control mapped to the editable field with an editable UI control.

13. The method of claim 10 further comprises:
if the field is determined to be complex, recursively drilling down the complex field until a simple sub-field is obtained; and
mapping the UI control to the simple sub-field.

14. The method of claim 2 wherein generating the layout comprises:
presenting the field information and the UI control mapping information to a user;
receiving one or more user selections of one or more of the fields;
generating a layout of suggested UI controls associated with the one or more user selected fields, wherein the suggested UI controls are retrieved from the UI control mapping information.

15. The method of claim 14 wherein presenting the layout for preview comprises retrieving data corresponding to the user selected fields from the data source and presenting the layout with the retrieved data.

16. The method of claim 2 further comprises exporting the layout to different UI frameworks.

17. A non-transitory computer-readable medium having stored thereon program code, the program code executable by a computer to:
analyze a data source to determine field information of the data source;
map UI controls to fields of the data source based on the field information to generate UI control mapping information;
generate a layout based on the field information and the UI control mapping information; and
present the layout for preview.

18. The non-transitory computer-readable medium of claim 17 wherein the program code is further executable by the computer to:
if the data source is determined to not support the metadata, analyze data from the data source to determine the field information.

19. A system comprising:
a non-transitory memory device for storing computer readable program code; and
a processor in communication with the memory device, the processor being operative with the computer readable program code to
analyze a data source to determine field information of the data source,
map UI controls to fields of the data source based on the field information to generate UI control mapping information,
generate a layout based on the field information and the UI control mapping information, and
present the layout for preview.

20. The system of claim 19 wherein the processor is further operative with the computer readable program code to:
if the data source is determined to not support the metadata, analyze data from the data source to determine the field information.
